(19) United States
(12) Patent Application Publication
(10) Pub. No.: US 2021/0237409 A1
(43) Pub. Date: Aug. 5, 2021

(54) COMPOSTABLE FLEXIBLE MATERIAL

(71) Applicant: COMPOSTABLE PAK LLC, La Porte, IN (US)

(72) Inventor: TRACE OSTERGREN, La Porte, IN (US)

(21) Appl. No.: 17/164,815

(22) Filed: Feb. 1, 2021

Related U.S. Application Data
(63) Continuation-in-part of application No. 16/779,631, filed on Feb. 2, 2020.

(51) Int. Cl. B32B 27/10; B32B 27/28; B32B 7/12; B32B 15/08; B32B 29/00; B32B 37/12

(52) U.S. Cl. CPC B32B 27/10; B32B 2307/31; B32B 7/12; B32B 15/08; B32B 29/002; B32B 37/12; B32B 2037/1215; B32B 2037/1276; B32B 2250/03; B32B 2439/70; B32B 2307/4023; B32B 2307/7163; B32B 2307/7246; B32B 2307/7244; B32B 2307/50; B32B 27/28

(57) ABSTRACT

A compostable flexible material comprising at least two layers, wherein all of the layers of the compostable flexible material are compostable. The compostable material can be heated in a microwave. A compostable packaging can be made from the compostable flexible material and comprises a compostable reclosable pressure closure.

### CROSS-REFERENCE TO RELATED APPLICATION

This patent application is a continuation-in-par of, and incorporates by reference as if fully restated herein, U.S. patent application Ser. No. 16/779,631 having the title “COMPOSTABLE FLEXIBLE MATERIAL” and filed Feb. 2, 2020 by the same inventor.

### BACKGROUND

Flexible materials have a wide variety of uses, from packaging materials for foodstuffs to display boards and/or stickers. Flexible materials in use today include a combination of plastic polymer films, metal foils as sealant layers and barrier layers, and adhesives that are not compostable. These conventional flexible materials are not biodegradable or compostable.

Not all flexible materials can be heated in a microwave. There are many materials that, when heated in a microwave, can catch fire, cause damage to the microwaving unit, or melt and destroy the contents contained inside flexible packaging.

There remains a need for a flexible material that is nearly 100% compostable and/or biodegradable. Further, there is a need for a compostable flexible material that can be heated in a microwave.

### SUMMARY

The present disclosure provides a compostable flexible material comprising at least two layers of material, wherein all of the layers are compostable and/or biodegradable. The present disclosure also provides a compostable flexible material that can be heated in a microwave. Generally, the present disclosure provides materials to be used in flexible packaging that are alternatives to petrochemicals for packaging applications and can be bio-based materials, such as plant based materials.

In one embodiment of the present disclosure, a compostable flexible material comprises a compostable barrier layer, a compostable sealant layer, a compostable adhesive layer there between.

In another embodiment of the present disclosure, a compostable flexible material comprises a compostable barrier layer, a compostable sealant layer, a compostable paper layer, a compostable adhesive layer between each of said layers.

In another embodiment of the present disclosure, a compostable flexible material comprises a compostable barrier layer, a compostable sealant layer, compostable ink applied to at least a portion of the compostable barrier layer.

In another embodiment of the present disclosure, a compostable flexible material comprises a compostable barrier layer, a compostable sealant layer, a compostable paper layer, compostable ink applied to at least a portion of the paper layer.

In another embodiment of the present disclosure, a compostable flexible material comprises a compostable barrier layer, a compostable sealant layer, a compostable paper layer, a compostable ink applied to at least a portion of the sealant layer, barrier layer, or the paper layer.

In another embodiment of the present disclosure, a compostable flexible material comprises a compostable barrier layer, a compostable sealant layer, a compostable paper layer, a compostable ink applied to at least a portion of the barrier layer and the paper layer, and can be heated in a microwave.

In another embodiment of the present disclosure, a compostable flexible material comprises a compostable barrier layer, a compostable sealant layer, a compostable adhesive layer therebetween, a compostable ink applied to at least a portion of the barrier layer or the sealant layer, and can be heated in a microwave.

In another embodiment of the present disclosure, a compostable flexible material comprises a compostable barrier layer, a compostable sealant layer, a compostable paper layer, a compostable adhesive layer between each of said layers, and a compostable ink applied to at least a portion of the barrier layer or the paper layer.

In another embodiment of the present disclosure, a compostable flexible material comprises a compostable barrier layer, a compostable sealant layer, a compostable paper layer, a compostable adhesive layer between each of said layers, a compostable ink applied to at least a portion of the barrier layer and the paper layer.

In another embodiment of the present disclosure, a compostable flexible material can comprise a barrier layer and the barrier layer is a biopolymer.

In another embodiment of the present disclosure, a compostable flexible material can comprise a sealant layer and the sealant layer is a biopolymer.

In an aspect of the present disclosure, the biopolymer can be a cellulose, polyhydroxyalkanoate (PHA), polylactic acid (PLA), polybutylene adipate terephthalate (PBAT), polybutylene Succinate (PBS), or combinations thereof.

In an aspect of the present disclosure, the sealant layer can be PHA and can be heated with a microwave.

In another embodiment of the present disclosure, a compostable packaging can be made from the compostable flexible material and comprise a front panel, a back panel, and a compostable reclosable pressure closure. The compostable flexible material can be used to make a compostable flexible packaging for containing foodstuff. The compostable flexible packaging can be heated by a microwave to warm or cook the foodstuff housed in the compostable flexible packaging.

In another embodiment of the present disclosure, the compostable reclosable pressure closure can be a tongue and groove closure, wherein the tongue portion of the closure is affixed to the front panel and the groove portion of the closure is affixed to the back panel.

In another embodiment of the present disclosure, the compostable reclosable pressure closure can be a tongue and groove closure, wherein the tongue portion of the closure is affixed to the back panel and the groove portion of the closure is affixed to the front panel.

In another embodiment of the present disclosure, the compostable reclosable closure can be a pressure closure, wherein the pressure closure comprises a hook to hook closure. One hook strip is affixed to the front panel and another hook strip is affixed to the back panel.

Those skilled in the art will further appreciate the above-mentioned advantages and superior features of the invention together with other important aspects thereof upon reading the detailed description which follows in conjunction with the drawings.

### BRIEF DESCRIPTION OF THE DRAWINGS

FIG. 1 illustrates a top perspective view of one embodiment of a compostable flexible material comprising at least three layers;

FIG. 2 illustrates a top perspective view of one embodiment of a compostable flexible material comprising at least 5 layers;

FIG. 3 illustrates a top perspective view of one embodiment of a compostable flexible material comprising compostable ink applied to at least one side of a paper layer or a barrier layer, or both;

FIG. 4 illustrates a side plan view of one embodiment of a compostable flexible material comprising at least three layers;

FIG. 5 illustrates a side plan view of one embodiment of a compostable flexible material comprising at least five layers; and

FIG. 6. Illustrates a top perspective view of one embodiment of a compostable flexible packaging 24 in accordance with the present disclosure.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use the present invention.

Accordingly, the detailed discussion herein of one or more embodiments is not intended, nor is it to be construed, to limit the boundaries of the descriptions but rather as defined by the claims and equivalents thereof. Therefore, embodiments not specifically addressed herein, such as adaptations, variations, modifications, and equivalent arrangements, should be and are considered to be implicitly disclosed by the illustrative embodiments and claims set forth herein and therefore fall within the scope of the present invention.

Further, it should be understood that, although steps of various claimed methods may be shown and described as being in a sequence or temporal order, the steps of any such method are not limited to being carried out in any particular sequence or order, absent an indication otherwise. That is, the claimed method steps are considered capable of being carried out in any sequential combination or permutation order while still falling within the scope of the present invention.

Additionally, it is important to note that each term used herein refers to that which a person skilled in the relevant art would understand such term to mean, based on the contextual use of such term herein. To the extent that the meaning of a term used herein, as understood by the person skilled in the relevant art based on the contextual use of such term, differs in any way from any particular dictionary definition of such term, it is intended that the meaning of the term as understood by the person skilled in the relevant art should prevail.

Furthermore, a person skilled in the art of reading claimed inventions should understand that “a” and “an” each generally denotes “at least one,” but does not exclude a plurality unless the contextual use dictates otherwise. Also, the term “or” denotes “at least one of the items,” but does not exclude a plurality of items of the list.

In the description which follows, like parts are marked throughout the specification and drawings with the same reference numerals, respectively. The drawing figures may not necessarily be to scale and certain features may be shown in somewhat schematic form in the interest of clarity and conciseness.

AEROBIC COMPOSTING means decomposition of organic matter using microorganisms that require oxygen.

ANAEROBIC COMPOSTING means decomposition that occurs using microorganisms that no not require oxygen to survive. In an anaerobic system, at least some of the chemical energy contained within the starting material is released as methane.

BIODEGRADEABLE means that the material, as a whole, or each layer of a flexible material, is capable of being broken down (decomposed) naturally or rapidly by the action of microorganisms.

COMPOSTABLE means that the material as a whole, or layer of a flexible material, is capable of disintegrating in a compost environment, and complies with the compostability standards set forth by, but not limited to, the following organizations: U.S. Composting Council, Environmental Protection Agency, American Society for Testing and Materials (ASTM International), or TUv Austria. The material can be disintegrated in an anaerobic and aerobic composting environment, and the disintegration of the material can be achieved through fungi digestion.

COMPOST ENVIRONMENT means an aerobic and/or anaerobic environment.

MICROWAVABLE or BE HEATED BY A MICROWAVE means the compostable material meets the standards set forth in, but not limited to, the FDA C.F.R. Title 21 guidelines, particularly under Subchapter B.

Biodegradable and compostable have become interchangeable terms by the public. These terms may also be interchanged in this disclosure.

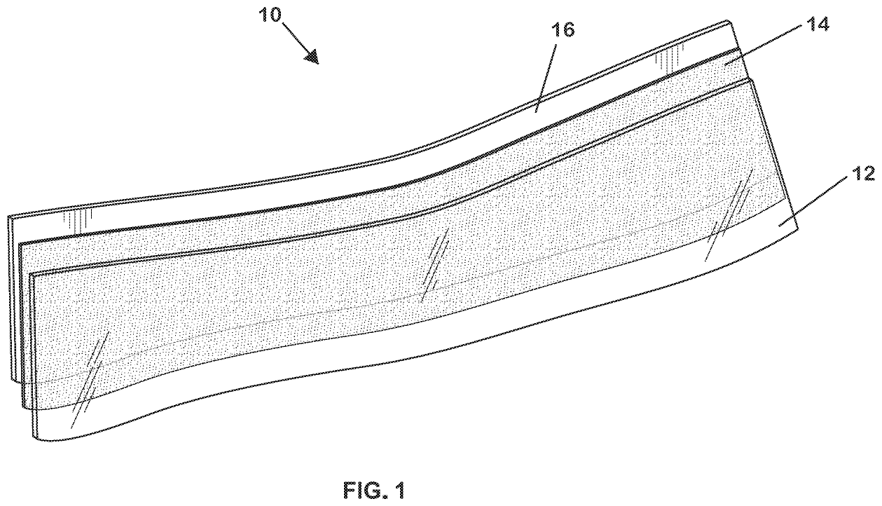

Referring to FIG. 1, there is illustrated one embodiment of a compostable flexible material and generally designated by the numeral 10. The compostable flexible material 10 can be composted and/or biodegrade within 2 months-16 months, 2 months-12 months, 2 months-10 months, 2 months-9 months, 2 months-7 months, 3 months-14 months, 3 months-10 months, 3 months-9 months, 3 months-8 months, 3 months-7 months, 3 months, 4 months, 5 months, 6 months, 7 months, 8 months, 9 months, 10 months, 11 months, 12, months, 13 months, 14 months, 15 months, 16 months, or any range of months, weeks, days therebetween. The compostable flexible material can comprise renewable resources as materials, can be certified as compostable in both industrial and/or home composting environments, and can be composted in any compost environment. The compostable flexible material 10 comprises moisture, UV/visible light, gas, aroma, oil, and grease barrier properties. The compostable flexible material 10 also comprises anti-static properties and dead-fold characteristics.

The compostable flexible material 10 can be used for any purpose that requires a flexible material, such as, but not limited to, consumer good packaging, stickers, labels, envelopes, shipping envelopes, food or edible product packaging, book covers, journal covers, notebook covers, and more. The compostable flexible material 10 can be used as packaging for dry foods, frozen storage, and wet foods. The compostable flexible material 10 is durable, and can have rigidity while still being flexible. One having ordinary skill in the art would understand how to modify the thickness of the layers or add more substrate to a respective layer to achieve a desired rigidity or flexibility.

The compostable flexible material 10 comprises at least two layers: a sealant layer 12 and a barrier layer 16. An adhesive layer 14 can be added therebetween, and the compostable flexible material 10 can comprise at least three layers. The at least two layers and adhesive layer 14 are each themselves compostable. The adhesive layer 14 can be a separate or stand-alone layer, as illustrated, or can be integrated into either the sealant layer 12 or the barrier layer 16 (not a stand-alone layer). Also, sealant layer 12 and barrier layer 16 can be separate or stand-alone layers, adhered to each other with adhesive layer 14, or can be integrated into each other and produced as “one layer” (not stand-alone layers). For ease of understanding this disclosure and the drawings, the sealant layer 12, adhesive layer 14, and barrier layer 16 are shown as stand-alone layers. The adhesive layer 14 can be situated between the sealant layer 12 and the barrier layer 16, and adheres the sealant layer 12 to the barrier layer 16. Once the at least three layers are adhered together, the compostable flexible material 10 is assembled, though additional layers may be added as desired.

The compostable flexible material 10 can be between 30-130 microns thick, or any range or single thickness therebetween, e.g., 35-125 microns, 40-110 microns, 45-105 microns, 50-100 microns, 35-100 microns, 60-100 microns, etc.

If the compostable flexible material 10 is used to make a compostable flexible packaging for shelf-stable, nonfrozen, or nonrefrigerated foodstuff, the compostable flexible material 10 can have a water vapor transmission of less than 3.0 g/100 sq. in/24 hr., (e.g. (all in g/100 sqin./24 hr) when the residual humidity is 90% at 38 degrees C., e.g., 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1.0, 0.99, 0.98, 0.97, 0.96, 0.95, 0.04, 0.93, 0.92, 0.91, 0.90, 0.89, 0.88, 0.87, 0.86, 0.85, 0.84, 0.83, 0.82, 0.81, 0.80, 0.79, 0.78, 0.77, 0.76, 0.75, 0.74, 0.73, 0.72, 0.71, 0.70, 0.69, 0.68, 0.67, 0.66, 0.65, 0.64, 0.63, 0.62, 0.61, 0.60, 0.59, 0.58, 0.57, 0.56, 0.55, 0.54, 0.53, 0.52, 0.51, 0.50, 0.49, 0.48, 0.47, 0.46, 0.45, 0.44, 0.43, 0.42, 0.41, 0.40, 0.39, 0.38, 0.37, 0.36, 0.35, 0.34, 0.33, 0.032, 0.31, 0.30, 0.29, 0.28, 0.27, 0.26, 0.25, 0.24, 0.23, 0.22, 0.21, 0.20, 0.19, 0.18, 0.17, 0.16, 0.15, 0.14, 0.13, etc.).

If the compostable flexible material 10 is used to make a compostable flexible packaging for shelf-stable, nonfrozen, or nonrefrigerated foodstuff, the compostable flexible material 10 can have an oxygen transmission of less than 2.0 cc/100 sq. in./24 hr. (e.g. (all in cc/100 sq. in/24 hr.) the residual humidity is 0% at 23 degrees C., e.g., 2.0, 1.9, 1.8, 1.75, 1.7, 1.6, 1.5, 1.4, 1.3, 1.2, 1.1, 1.0, 0.9, 0.8, 0.7, 0.6, 0.5, 0.4, 0.3, 0.2, 0.1, 0.09, 0.08. 0.075, 0.07, 0.065, 0.06, 0.055, 0.05, 0.045, 0.04, 0.035, 0.03, 0.025, 0.02, etc.).

If the compostable flexible material 10 is used to make a compostable flexible packaging for nonshelf-stable, frozen, or refrigerated foodstuff, the compostable flexible material 10 can have a water vapor transmission of less than 25.0 g/100 sq. in/24 hr., and greater than 1.0 g/100 sq. in/24 hr (e.g. (all in g/100 sqin./24 hr) when the residual humidity is 90% at 38 degrees C., e.g., 25.0, 24.5, 24.0, 23.5, 23.0, 22.5, 22.0, 21.5, 21.0, 20.5, 20.0. 19.5, 19.0, 18.5, 18.0, 17.5, 17.0, 16.5, 16.0, 15.5, 15.0, 14.5, 14.0, 13.5, 13.0, 12.5, 12.0, 11.5, 11.0, 10.5, 10.0, 9.5, 9.0, 8.5, 8.0, 7.5, 7.0, 6.5, 6.0, 5.5, 5.0, 4.5, 4.0, 3.5, 3.0, 2.5, 2.0, 1.5, or 1.0.

If the compostable flexible material 10 is used to make a compostable flexible packaging for nonshelf-stable, frozen, or refrigerated foodstuff, the compostable flexible material 10 can have an oxygen transmission of less than 40.0 cc/100 sq. in./24 hr. (e.g. (all in cc/100 sq. in/24 hr.) the residual humidity is 0% at 23 degrees C., e.g., 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, 1, 0.9, 0.8, 0.7, 0.6, 0.5, 0.4, 0.3, or 0.2.

The sealant layer 12 can be made from a renewable resource, such as a biopolymer material that is safe for contact with food. The sealant layer 12 may comprise or may not comprise a metalized portion. The sealant layer 12 can be made from a biopolymer such as cellulose, polyhydroxyalkanoate (PHA), polylactic acid (PLA), polybutylene adipate terephthalate (PBAT), polybutylene Succinate (PBS), or combinations thereof. PLA is a thermoplastic aliphatic polyester derived from renewable resources.

Generally, biopolymers can be produced using different methods: either directly from natural substances that include polysaccharides and proteins, or by polymerization of monomers derived from biomass such as PLA from lactic acid. Other biopolymers can be produced by microorganisms such as polyhydroxyalkanoate (PHA).

The sealant layer 12 can be a transparent biopolymer film and cold-pressed or extruded through a machine. The sealant layer 12 can be colored with compostable dye, if so desired. The sealant layer 12 can be transparent, semi-transparent, translucent, or opaque. The sealant layer 12 contacts food when the compostable flexible material 10 is used to make food packaging. The side of the sealant layer 12 that comes into contact with food will not comprise a metalized portion. The side of the sealant layer 12 that is opposite of the food can comprise a metalized portion.

The adhesive layer 14 can be transparent, semi-transparent, translucent, or opaque material made from renewable resources. The adhesive layer 14 can be water-based long-chain adhesive polymer, which is a fully reacted system. The adhesive layer 14 can adhere to porous or non-porous substrates, and can adhere porous substrates to non-porous substrates. The adhesive layer 14 comprises a first side and a second side, and each side may be sticky. The adhesive layer 14 comprises a first side and a second side, and either the first side or the second side may be sticky. The adhesive layer 14 may be formulated as a solution, or a powder, and sprayed onto a compostable substrate, or mixed with the compostable substrate and extruded through a machine as a thin film. The adhesive property of the adhesive layer 14 is activated as the water evaporates or is absorbed by the substrate. The adhesive layer 14 can be a permanent adhesive or a pressure sensitive adhesive. A pressure sensitive adhesive is a semi-permanent adhesive that retains viscosity when it is applied to a substrate. The viscosity of the adhesive can be between 13-75 mPas, 13-70 mPas, 13-65 mPas, 15-70 mPas, 20-70 mPas, 25-70 mPas, 30-75 mPas, 35-65 mPas, or any specific viscosity therebetween. The adhesive layer 14 can be kept slightly viscous by adding more water, say 2%-15% or any % therebetween, to the standard protocol for making a fully reacted water based long-chain adhesive polymer. The adhesive layer 14 can also be turned into a pressure sensitive adhesive by adding a thin cloth to the substrate.

The adhesive layer 14 may be a water-based adhesive and comprise polyolefines or a metal oxide substrate as a form for holding or applying the adhesive layer 14, and have a pH between 6-10, 7-10, 8-10, 9-10, 10, 6-7, 6-8, 6-9, 7-9, 7-8, 6, 7, 8, 9, 10, or pH values therebetween.

The adhesive layer 14 can be a compostable hot-melt adhesive.

The barrier layer 16 can be made from renewable resources, and can be a transparent cellulose film and cold-pressed or extruded through a machine. The barrier layer 16 can be a metallized material that comprises a high luster shine or sparkle. If the compostable flexible material 10 comprises a stand-alone barrier layer 16, the barrier layer 16 is disposed above the sealant layer 12. Neither side of the barrier layer 16 will contact food if the compostable flexible material 10 is used to make food packaging.

In some embodiments, the metalized portion of the sealant layer 12 or the barrier layer 16 comprises at least one metal oxide selected from the group of titania, alumina, and combinations thereof. In further embodiments, the metalized portion of the sealant layer 12 and the barrier layer 16 can be deposited said layer by various deposition techniques, such as vacuum metallization. The degree of deposition/metallization on sealant layer 12 and metal layer 16 can be determined by measuring the optical density of the susceptor (i.e., the substrate after coating deposition). In various embodiments, the susceptor can have an optical density of from about 1 Tobias to about 5 Tobias, from about 1 Tobias to about 4 Tobias, from about 1 Tobias to about 3 Tobias, from about 1 Tobias to about 2 Tobias, from about 1.5 Tobias to about 4 Tobias, from about 1.5 Tobias to about 3.5 Tobias, from about 1.5 Tobias to about 3 Tobias, from about 2 Tobias to about 5 Tobias, from about 2 Tobias to about 4 Tobias, from about 2 Tobias to about 3 Tobias, from about 3 Tobias to about 5 Tobias, from about 3 Tobias to about 4 Tobias, or from about 4 Tobias to about 5 Tobias.

The metal oxide can be randomly distributed or can be patterned on the sealant layer 12 or the barrier layer 16. Exposed portions of the sealant layer 12 or the barrier layer 16 can be coated and unexposed portions cannot be coated when the metal oxide is distributed on said layer. In some aspects of the present disclosure, the patterned distribution can be a non-random pattern. In some aspects of the present disclosure, the patterned distribution can be a geometric pattern.

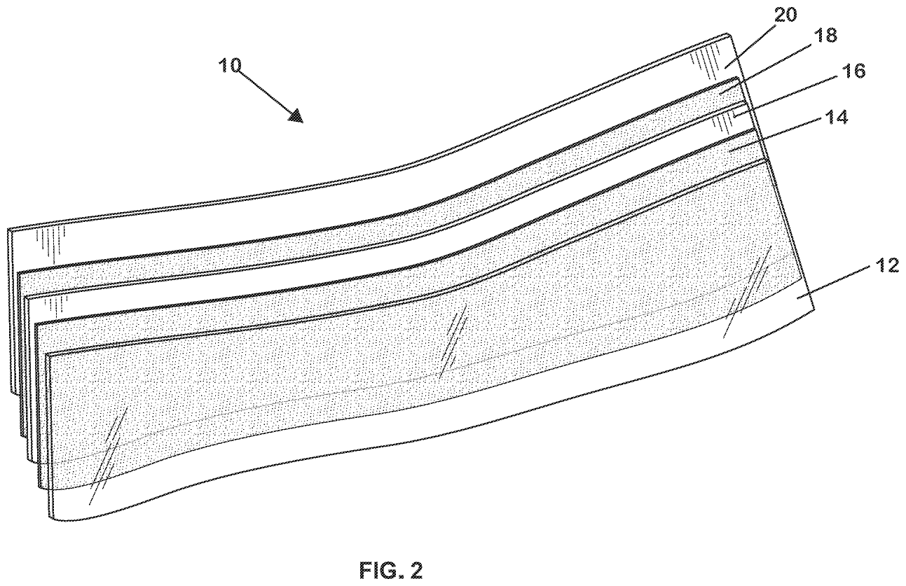

Turning to FIG. 2, another embodiment of a compostable flexible material 10 is shown. The compostable flexible material 10 can comprise renewable resources as materials, can be certified as compostable in both industrial and home composting environments, and can be suitable for anaerobic digestion. The compostable flexible material 10 comprises moisture, UV/visible light, gas, aroma, oil, and grease barrier properties. The compostable flexible material 10 also comprises anti-static properties and dead-fold characteristics.

The compostable flexible material 10 can comprise at least five layers: a sealant layer 12, at least two adhesive layers 14 and 18, a barrier layer 16, and a paper layer 20. The at least five layers are each themselves compostable. The at least two adhesive layers 14 and 18 can be separate layers, as illustrated, or can be integrated into one or both sides of either the sealant layer 12, or the barrier layer 16, or the paper layer 20. For ease of understanding this disclosure and the drawings, the at least two adhesive layers 14 and 18 are shown as stand-alone layers. One of the at least two adhesive layers 14 and 18 can be situated between the sealant layer 12 and the barrier layer 16 and adheres the sealant layer 12 to the barrier layer 16. The other of the at least two adhesive layers 14 and 18 can be situated between the barrier layer 16 and the paper layer 20, and adheres the barrier layer 16 to the paper layer 20. The adhesive layers 14 and 18 can each be a separate or stand-alone layer, as illustrated, or can be integrated into either the sealant layer 12 or the barrier layer 16 (not a stand-alone layer). Also, sealant layer 12 and barrier layer 16 can be separate or stand-alone layers, adhered to each other with adhesive layer 14, or can be integrated into each other and produced as “one layer” (not stand-alone layers). For ease of understanding this disclosure and the drawings, the sealant layer 12, adhesive layers 14 and 18, and barrier layer 16 are shown as stand-alone layers.

Once the at least five layers are adhered together, the compostable flexible material 10 is assembled, though additional layers may be added as desired.

The paper layer 20 can comprise at least one layer of paper. The paper layer 20 can comprise recycled paper or new paper, and the paper can be made from animal waste, hair, plants, fungus, fruits, vegetables, wood, or combinations thereof.

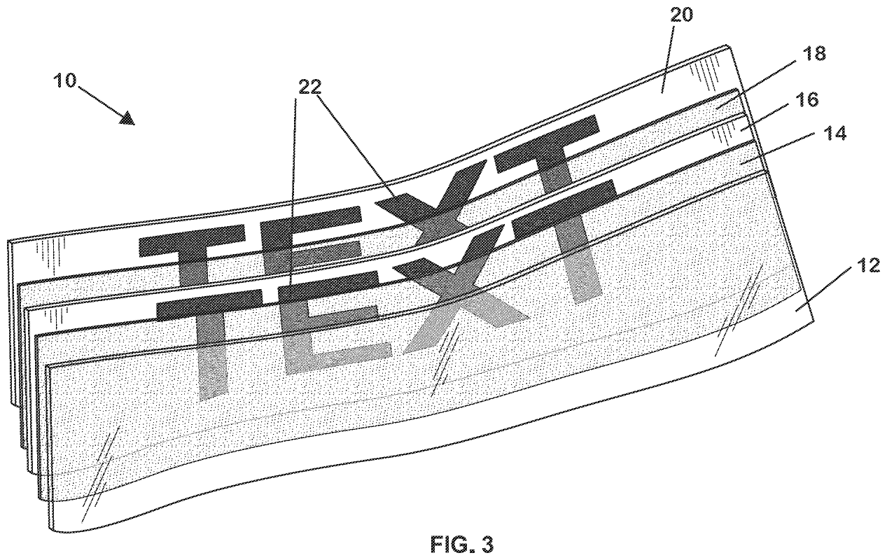

Turning to FIG. 3, another embodiment of a compostable flexible material is shown. The compostable flexible material 10 can comprise renewable resources as materials, can be certified as compostable in both industrial and home composting environments, and can be suitable for anaerobic digestion. The compostable flexible material 10 comprises moisture, UV/visible light, gas, aroma, oil, and grease barrier properties. The compostable flexible material 10 also comprises anti-static properties and dead-fold characteristics.

The compostable flexible material 10 can comprise at least three layers or at least five layers (five layers are shown in FIG. 3, though three layers can be sufficient): a sealant layer 12, an adhesive layer 14, a barrier layer 16, and optionally, an adhesive layer 18, a paper layer 20, and/or a compostable ink 22 applied to at least a portion of the barrier layer 16 or the paper layer 20. The adhesive layer 14 and adhesive layer 18 can be separate layers, as illustrated, or can be integrated into one or both sides of either the sealant layer 12, or the barrier layer 16, or the paper layer 20. For ease of understanding this disclosure and the drawings, the adhesive layer 14 and adhesive layer 18 are shown as stand-alone layers. The adhesive layer 14 can be situated between the sealant layer 12 and the barrier layer 16 and adheres the sealant layer 12 to the barrier layer 16. The adhesive layers 18 can be situated between the barrier layer 16 and the paper layer 20, and adheres the barrier layer 16 to the paper layer 20.

The adhesive layer 14 can be a separate or stand-alone layer, as illustrated, or can be integrated into either the sealant layer 12 or the barrier layer 16 (not a stand-alone layer). Also, sealant layer 12 and barrier layer 16 can be separate or stand-alone layers, adhered to each other with adhesive layer 14, or can be integrated into each other and produced as “one layer” (not stand-alone layers). For ease of understanding this disclosure and the drawings, the sealant layer 12, adhesive layer 14, and barrier layer 16 are shown as stand-alone layers.

Once the at least three layers, or optionally, the at least five layers are adhered together, the compostable flexible material 10 is assembled, though additional layers may be added as desired.

The compostable ink 22 can be made of dye made from vegetable, plants, fungus, fruit, algae, insects, treated waste, soy, water-based ink, or combinations thereof, and be substantially free of zinc, copper, nickel, cadmium, lead, mercury, chromium, molybdenum, selenium, arsenic and/or flour. The compostable ink 22 may be applied to at least a portion of the barrier layer 16. The compostable ink 22 may be applied to at least a portion of the paper layer 20. The compostable ink 22 may be applied to at least a portion of the barrier layer 16, or the paper layer 20. The compostable ink 22 may be applied to both the barrier layer 16 and the paper layer 20.

The sealant layer 12 and the adhesive layer 14 may be translucent or transparent to allow the compostable ink 22 to be seen. The compostable ink 22 may be applied to either side of the barrier layer 16, or to either side of the paper layer 20, or to both sides of the barrier layer 16, the paper layer 20, or both the barrier layer 16 and the paper layer 20. The compostable ink can be laser printed, flexographic printed, off-set printing, digital printed, dot matrix printed, screen printed, hand written, or hand drawn on the barrier layer 16, the paper layer 20, or both the barrier layer 16 and the paper layer 20. The compostable ink 22 may be applied in the form of text, graphics, pictures, solid colors, murals, or combinations thereof. FIG. 3 is not meant to be limited to just text printed in compostable ink 22 on at least a portion of the compostable flexible material 10, the barrier layer 16, and/or the paper layer 20.

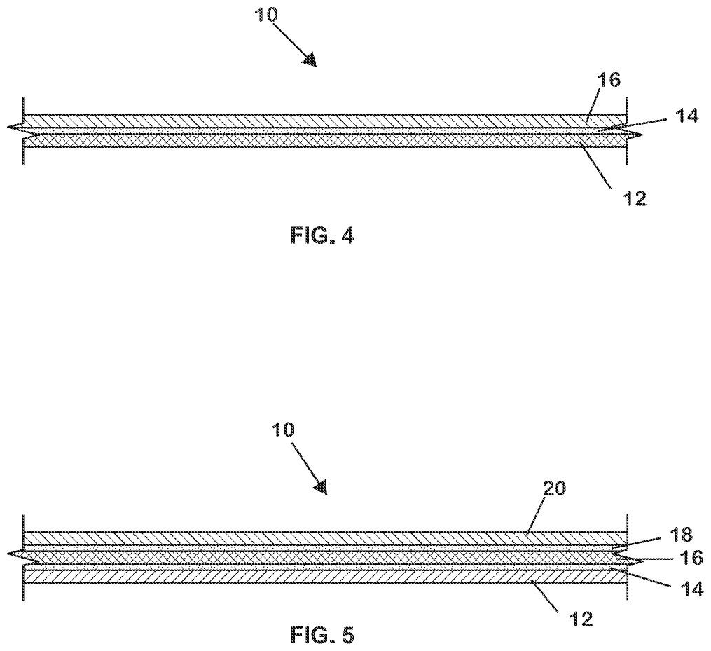

Turning to FIG. 4, a side plan view of one embodiment of the compostable flexible material 10 can be seen.

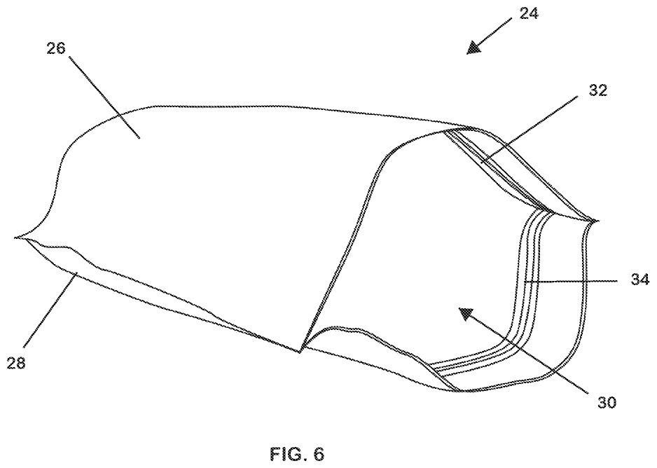

Turning to FIG. 5, a side plan view of one embodiment of the compostable flexible material 10 can be seen.

Turning to FIG. 6, a top perspective view of one embodiment of a compostable flexible packaging 24 is illustrated in accordance with the present disclosure. The compostable flexible packaging 24 can comprise a front panel 26, a back panel 28, a cavity 30, a reclosable pressure closure having a first portion of the reclosable compostable pressure closure 32 and a second portion of the pressure closure 34. The compostable flexible packaging 24 is illustrated for exemplary purposes and this disclosure is not intended to be limited by the illustration. The compostable flexible packaging 24 is any type of packaging that comprises the compostable flexible material 10, such as a stand-up pouch as shown, a pillow pouch (not shown), or a gusseted bag (not shown). The compostable flexible packaging 24 can comprise a central cavity 30 for receiving items, such as foodstuff, to be contained in the compostable flexible packaging 24.

The compostable flexible packaging 24 can comprise a reclosable pressure closure, such as can be a tongue and groove closure, wherein the tongue portion of the closure is affixed to the front panel 26 and the groove portion of the closure is affixed to the back panel 28.

The compostable reclosable pressure closure can be a tongue and groove closure, wherein the tongue portion of the closure is affixed to the back panel 28 and the groove portion of the closure is affixed to the front panel 26.

The compostable reclosable closure can be a pressure closure, wherein the pressure closure comprises a hook to hook closure. One hook strip can be a first portion of the compostable pressure closure 32 affixed to the front panel 26. Another hook strip can be a second portion of the compostable pressure closure 24 and can be affixed to the back panel 28.

The compostable flexible packaging 24 may or may not comprise a bottom and may or may not be gusseted. The compostable flexible packaging 24, front panel 26, and back panel 28 can be formed from one continuous sheet of the compostable flexible material 10 or formed from a single source of the compostable flexible material 10. The compostable flexible packaging 24 may also be heated using a microwave to cook or warm foodstuff contained in the central cavity 30.

It is important to recognize that this disclosure has been written as a thorough teaching rather than as a narrow dictate or disclaimer. Reference throughout this specification to “one embodiment”, “an embodiment”, or “a specific embodiment” means that a particular feature, structure, or characteristic described in connection with the embodiment is included in at least one embodiment and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other embodiments. It is to be understood that other variations and modifications of the embodiments described and illustrated herein are possible in light of the teachings herein and are to be considered as part of the spirit and scope of the present subject matter.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

The foregoing description of illustrated embodiments, including what is described in the Abstract and the Summary, and all disclosure and the implicated industrial applicability, are not intended to be exhaustive or to limit the subject matter to the precise forms disclosed herein. While specific embodiments of, and examples for, the subject matter are described herein for teaching-by-illustration purposes only, various equivalent modifications are possible within the spirit and scope of the present subject matter, as those skilled in the relevant art will recognize and appreciate. As indicated, these modifications may be made in light of the foregoing description of illustrated embodiments and are to be included, again, within the true spirit and scope of the subject matter disclosed herein.

Thus, although the foregoing disclosure has been described in some detail by way of illustration and example for purposes of clarity and understanding, it will be obvious that certain changes and modifications may be practiced within the scope of the disclosure, as limited only by the scope of the claims.

I claim:

1. A compostable flexible material comprising:
at least two layers comprising a sealant layer, a barrier layer, and at least one adhesive layer therebetween, wherein each of the layers are compostable;
the barrier layer being a biopolymer not derived from petroleum;
the sealant layer being a biopolymer not derived from petroleum; and
a water vapor transmission of less than 3.0 g/100 sq. in/24 hr. at 90% humidity at 23 degrees C., and an oxygen transmission of less than 2.0 cc/100 sq. in./24 hr. at 0% humidity at 23 degrees C.

2. The compostable flexible material of claim 1, wherein at least one of the barrier layer or the sealant layer comprises a metallized portion of the layer.

3. The compostable flexible material of claim 2, wherein a metallized portion of at least one of the barrier layer or the sealant layer comprises at least one metal oxide selected from the group of titanium, aluminum, copper, nickel, zinc, gold, silver, tin, iron, or combinations thereof.

4. The compostable flexible material of claim 3, further comprising a paper layer.

5. The compostable flexible material of claim 1, further comprising compostable ink applied to at least a portion of the compostable flexible material.

6. The compostable flexible material of claim 1, wherein the biopolymer is a material selected from the group of cellulose, polyhydroxyalkanoate (PHA), polylactic acid (PLA), polybutylene adipate terephthalate (PBAT), polybutylene Succinate (PBS), or combinations thereof.

7. The compostable flexible material of claim 1, wherein the at least one adhesive layer is a hot-melt adhesive or a compostable water-based adhesive.

8. A compostable packaging for foodstuff comprising:
a front panel made from the compostable flexible material of claim 1;
a back panel made from the compostable flexible material of claim 1, wherein the front panel and back panel are formed from a single source of the compostable flexible material; and
and a compostable reclosable pressure closure, wherein the reclosable pressure closure comprises a first pressure closure portion and a second pressure closure portion, wherein the first pressure closure portion is incorporated on the front panel of the compostable packaging and the second pressure closure portion is incorporated on the back panel of the compostable packaging.

9. The compostable packaging for foodstuff of claim 8, further comprising a paper layer, compostable ink applied to at least a portion of the compostable flexible material, and at least two adhesive layers, wherein one of the at least two adhesive layers is disposed between the barrier layer and sealant layer, and the other of the at least two adhesive layers is disposed between the barrier layer and the paper layer.

10. The compostable packaging for foodstuff of claim 9, wherein the at least one adhesive layer is a compostable hot-melt adhesive or a compostable water-based adhesive.

11. A compostable flexible material comprising:
a barrier layer, a sealant layer, and at least one adhesive layer therebetween, wherein each of the layers are compostable;
a water vapor transmission of less than 25 g/100 sq. in/24 hr. at 90% humidity and 38 degrees C., and an oxygen transmission of less than 40 cc/100 sq. in/24 hr. at 0% humidity at 23 degrees C.;
the barrier layer being a biopolymer not derived from petroleum; and
the sealant layer being a biopolymer not derived from petroleum.

12. A compostable packaging for foodstuff comprising:
a front panel made from the compostable flexible material of claim 11;
a back panel made from the compostable flexible material of claim 11, wherein the front panel and back panel are formed from a single source of the compostable flexible material; and
a compostable reclosable pressure closure, wherein the reclosable pressure closure comprising a first pressure closure portion and a second pressure closure portion, wherein the first pressure closure portion is incorporated on a front panel of the compostable packing and the second pressure closure portion is incorporated on a back panel of the compostable packaging.

13. The compostable packaging for foodstuff of claim 12, wherein the at least one adhesive layer is a compostable hot-melt adhesive or a compostable water-based adhesive.

14. The compostable flexible material of claim 11, further comprising a compostable ink, wherein the compostable ink is applied to at least a portion of the barrier layer or the sealant layer.

15. The compostable flexible material of claim 11, further comprising a paper layer, and at least two adhesive layers, wherein one of the at least two adhesive layers is disposed between the barrier layer and sealant layer, and the other of the at least two adhesive layers is disposed between the barrier layer and the paper layer.

16. The compostable flexible material of claim 11, wherein the compostable flexible material can be heated by a microwave to warm or cook foodstuff contained in packaging made from the compostable flexible material.

17. The compostable flexible material of claim 15, wherein at least one of the at least two adhesive layers is a compostable water-based adhesive or a compostable hot-melt.

18. The compostable flexible material of claim 11, further comprising a metalized portion of the barrier layer.

19. The compostable flexible material of claim 11, wherein the biopolymer for the sealant layer is made from a material selected from the group of cellulose, polyhydroxyalkanoate (PHA), polylactic acid (PLA), polybutylene adipate terephthalate (PBAT), polybutylene Succinate (PBS), or combinations thereof.

20. A microwavable compostable flexible packaging for foodstuff, the microwavable compostable flexible packaging comprising:
the compostable flexible packaging of claim 12, further comprising
a compostable ink;
the sealant layer being integrated with the barrier layer, wherein the sealant layer and the barrier layer are made from a material selected from the group of cellulose, polyhydroxyalkanoate (PHA), polylactic acid (PLA), polybutylene adipate terephthalate (PBAT), or polybutylene Succinate (PBS); and
the compostable ink being applied to at least a portion of the sealant layer integrated with the barrier layer, wherein the compostable flexible material can be heated by a microwave to warm or cook foodstuff contained in the microwavable compostable flexible packaging made from the compostable flexible material.
